(19) United States
(12) Patent Application Publication
(10) Pub. No.: US 2015/0338630 A1
(43) Pub. Date: Nov. 26, 2015

(54) Device for marking a sample, and observation system comprising such a marking device

(71) Applicants: COMMISSARIAT À LÉNERGIE ATOMIQUE ET AUX ÉNERGIES ALTERNATIVES, Paris (FR); BIOMÉRIEUX, MARCY L' ETOILE (FR)

(72) Inventors: Pierre JOLY, GRENOBLE (FR); Emmanuelle SCHULTZ, SAINT EGREVE (FR)

(21) Appl. No.: 14/758,747

(22) PCT Filed: Dec. 30, 2013
(86) PCT No.: PCT/EP2013/078151

§ 371 Date: Jun. 30, 2015

(30) Foreign Application Priority Data
Dec. 31, 2012 (FR) 12 62994

(51) Int. Cl. G02B 21/34; G06F 3/03; G02B 21/26; G06K 19/06

(52) U.S. Cl. CPC G02B 21/34; G06K 19/06009; G06F 3/0317; G02B 21/26

(57) ABSTRACT

This marking device for marking a sample is intended to be placed facing the sample for observing the sample by means of an observation system. The marking device comprises a plurality of meshes forming a meshing, the marking device comprising at least one identification marking of each mesh.

Each identification marking corresponds to an identifier of the mesh and includes a main marking and at least one secondary marking, the identifier of said mesh depending on the position of each secondary marking with respect to the main marking.

Each identification marking includes a plurality of secondary markings, and the identifier includes a first number and a second number, both numbers being expressed in a respective arithmetic base, and each secondary marking both corresponds to a respective figure of the first number and to a respective figure of the second number.

### BACKGROUND OF THE INVENTION

The present invention relates to a marking device for marking a sample, the marking device being intended to be placed facing the sample with view to observing the latter. In order to mark a portion of the observed sample, the marking device includes a plurality of meshes forming a meshing, each mesh including an identification marking.

The present invention also relates to an observation system comprising a sample support, a light source able to illuminate the sample support, and such a marking device.

Additionally, the observation system comprises an observation device for observing at least one image of a sample able to be laid out on the sample support.

The invention in particular applies to marking devices for observation by means of an optical microscope.

During the observation of different elements of a sample by means of an optical microscope, the observation area generally has limited dimensions as compared with the overall dimensions of the sample to be observed. The observation area is typically a rectangle, the side of which has a value comprised between 100 μm and 1 mm, while the sample typically has dimensions comprised between 5 mm and 20 mm. The observation area corresponds to the intersection between the field of the observation device and the sample support.

It is then often complex to mark the observation area in the sample to be observed. It is notably delicate to find a particular observation area when the observation area has changed in order to explore other portions of the sample with the optical microscope, or further when the observation of another sample has been carried out before returning to this sample. This problem is also posed during the change of the device for observing the sample, which causes a modification of the magnification or of the orientation of the sample with respect to the previous observation.

In order to find a remedy to this problem, it is known how to use a microscope equipped with a motor-driven translational stage. However, such a motor-driven stage is relatively costly and further requires that the different positions of the observation areas be noted, or further the use of an additional piece of software capable of carrying out a survey of the different positions.

The use of a sample support with the shape of a graduated transparent strip is also known. Such a strip includes a grid consisting of continuous lines, this grid defining a meshing. Each cell of this grid, also called meshing, is distinguished from the other ones by an identification marking assuming the form of chains of alphanumerical characters, such as capital letters or figures.

The whole of these cells, lines and identification markings are produced with a sufficiently small pitch so as to be always present in a reduced observation field and also with a sufficient size so as to be visible. The result of this is that a significant portion of the surface of the graduated strip is covered by these identification markings.

### SUMMARY OF THE INVENTION

The object of the invention is therefore to propose a marking device giving the possibility of easily marking a mesh from among the whole of the meshes, while optimizing the free surface of the marking device, i.e. the surface of the marking device free of identification markings. A larger free space is then available than in the state of the art, while allowing accurate marking of the observed mesh on the marking device.

To this end, the object of the invention is a marking device of the aforementioned type, in which each identification marking corresponds to an identifier of the mesh and includes a main marking and at least one secondary marking, the identifier of said mesh depending on the position of each secondary marking with respect to the main marking,

wherein, preferably, each identification marking includes a plurality of secondary markings, and

wherein, preferably, the identifier includes a first number and a second number, both numbers being expressed in a respective arithmetic base, and each secondary marking both corresponds to a respective figure of the first number and to a respective figure of the second number.

According to other advantageous aspects of the invention, the marking device comprises one or several of the following features, taken individually or according to all the technically possible combinations:
the identification marking, including the main marking and each secondary marking, is distinct from an alphanumerical coding;
the main marking has an asymmetric shape able to indicate an orientation of said mesh;
the arithmetic basis is the decimal basis;
the value of the figure depends on the distance between the corresponding secondary marking and the main marking;
each mesh includes a reference system, the identifier being determined from coordinates of each secondary marking in this reference system;
each mesh includes a reference system, and the main marking forms a scale for determining at least one coordinate of each secondary marking according to at least one axis of this reference system;
the main marking forms a scale for determining the coordinates of each secondary marking along each axis of the reference system;
each secondary marking has a size of dimensions less than or equal to 10 μm×10 μm;
the secondary markings are of a size and/or a shape distinct from one secondary marking to the other; and
the main marking has a size of dimensions less than or equal to 20 μm×40 μm, preferably of dimensions less than or equal to 15 μm×30 μm, still preferably of dimensions less than or equal to 10 μm×20 μm.

The object of the invention is also an observation system comprising a sample support, a light source able to illuminate the sample support, and a marking device for marking a sample, the sample being intended to be positioned on the sample support, in which the marking device is as defined above.

### BRIEF DESCRIPTION OF THE DRAWINGS

According to other advantageous aspects of the invention, the observation system comprises one or several of the following features, taken individually or according to all the technically possible combinations:
the marking device is positioned facing the sample support; and
the sample support includes a plate for receiving the sample, and the marking device is made on said plate.

The features and advantages of the invention will become apparent upon reading the description which follows, only given as a non-limiting example, and made with reference to the appended drawings, wherein:

FIG. 1 is a schematic illustration of an observation system comprising a microscope, a sample support able to receive a sample and marking device for marking the sample placed facing the sample for observing the latter,

FIG. 2 is a schematic illustration of a mesh of the marking device of FIG. 1, and of an identification marking of said mesh according to an embodiment of the invention, the identification marking including a main marking and secondary markings,

FIG. 3 is an image of several identification markings of FIG. 2,

FIGS. 4 and 5 are schematic illustrations of the main marking, and of the secondary markings respectively, of the identification marking according to an additional aspect,

FIGS. 6 and 7 are schematic illustrations of two exemplary identification markings according to this additional aspect,

FIG. 8 is a view similar to that of FIG. 3 according to this additional aspect, and

FIG. 9 is a view similar to that of FIG. 5 according to an alternative.

### DETAILED DESCRIPTION OF PREFERRED EMBODIMENTS

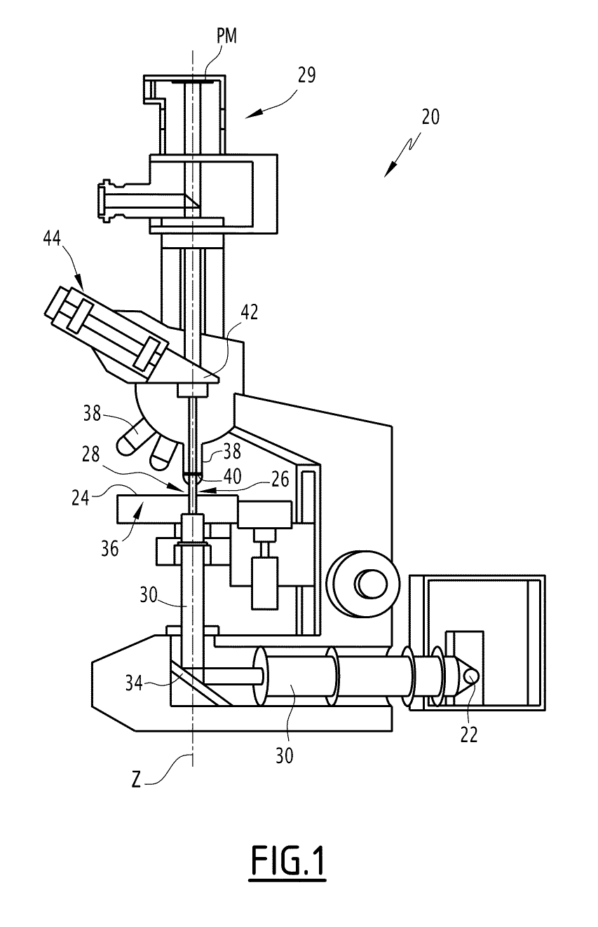

In FIG. 1, an observation system 20 comprises a light source 22, a support 24 of a sample 26 and a marking device 28 for marking the sample 26, the marking device 28 being intended to be placed facing the sample 26 for observing the sample 26 by means of the observation system 20.

Additionally, the observation system 20 comprises an image acquisition device 29. The observation system 20 then forms an imaging system.

The observation system 20 is intended to achieve observation of an image of the sample 26 when the latter is laid out on the sample support 24.

The light source 22 is able to emit a light beam 30 in order to illuminate the sample 26 positioned on the sample support 24.

In the example of FIG. 1, the observation system 20 is an optical microscope, and then includes a mirror 34 able to reflect the light beam 30, stemming from the light source 22, towards the sample support 24 along a vertical direction Z. The microscope 20 comprises a stage 36 on which is positioned the sample support 24. The microscope 20 additionally includes three objectives 38, each objective 38 including a first lens 40, also called an objective lens. Each objective 38 allows observation of a sample with different magnification. Additionally, the microscope 20 includes a splitter device 42, such as a prism, and an eyepiece 44, the splitter device 42 being able to direct the radiation transmitted through the sample support 24 and the sample 26, towards the eyepiece 44 on the one hand, and towards the image acquisition device 29 on the other hand.

The microscope 20 allows observation of a portion of the sample support 24, this portion being called an observation area.

The sample support 24 includes a plate, not shown, for receiving the sample 26. The sample support 24 is preferably a planar support.

The sample support 24 is transparent, and is for example with a shape of a transparent slide for observation by means of the microscope. Alternatively, the sample support 24 is opaque, and is for example with the shape of a silicon plate.

The sample support 24 is for example positioned between the light source 22 and the image acquisition device 29 when the image acquisition device 29 is able to acquire images of the radiation transmitted through the sample support 24 on which is laid out the sample 26. The sample support 24 is then substantially perpendicular to the direction of illumination of the sample 26, illustrated by the vertical direction Z in FIG. 1.

The sample support 24 has a thickness along the vertical direction Z, with a value for example comprised between 50 μm and 1 mm, preferably comprised between 100 μm and 500 μm, generally 170 μm.

In order to localize a given observation area on the sample support 24, the marking device 28 is divided according to a meshing including a plurality of meshes 50, each mesh 50 being localized by at least one identification marking 52. Thus, each observation area is spatially localizable, with respect to the marking device 28, by identification of a mesh 50 covered by said area. This identification is obtained by decoding the identification marking 52 corresponding to said mesh 50.

The marking device 28, object of the invention, is either integrated to the sample support 24, or intended to be applied facing the latter. It then appears as a device distinct from the sample support 24. The term “facing” means that the marking device 28 is placed facing the sample support 24 without necessarily being placed in contact with the sample support 24.

In the examples described below, as non-limiting, the marking device 28 is integrated to the sample support 24, and the marking device 28 is then for example made on the plate of the sample support 24 intended to receive the sample 26.

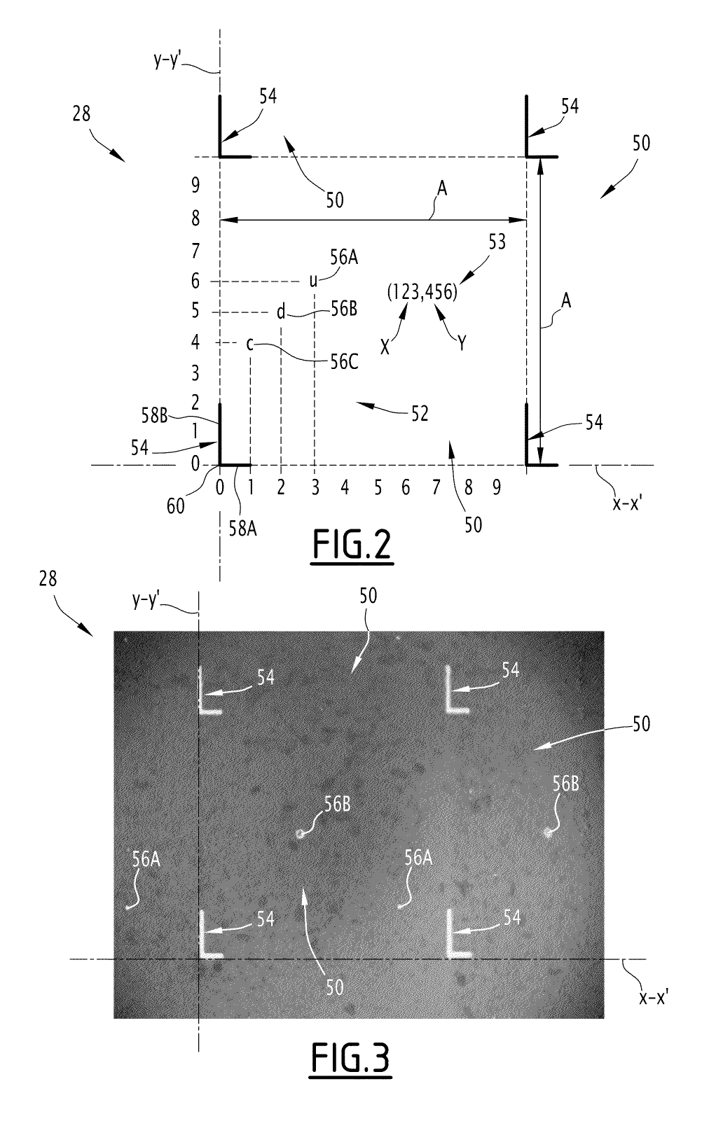

The marking device 28 comprises the plurality of meshes 50, defining a meshing, and each identification marking 52 of said corresponding mesh 50 as illustrated in FIG. 2. This identification marking 52 also allows delimitation of the mesh 50 in the observation area. In the example of FIG. 2, the marking device 28 includes a plurality of meshes 50 and an identification marking 52 for each mesh 50.

The image acquisition device 29 is able to acquire images of the sample 26 illuminated by the light beam 30.

The image acquisition device 29 for example comprises a photodetector array PM, visible in FIG. 1, such as a CMOS (complementary metal oxide semi-conductor) sensor or further CCD (charged-coupled device) sensor, including a plurality of pixels, not shown.

Each mesh 50 is intended to receive an element, not shown, of the sample 26 for observing at least one image of the sample element by means of the observation system 20.

Each mesh 50 for example is in the form of a quadrilateral, for example a square of side A, the value of A being comprised between 50 μm and 1 mm, preferably equal to 100 μm.

Each identification marking 52 corresponds to an identifier 53 of the mesh 50, the identifier 53 being unique for said mesh 50. Each identification marking 52 includes a main marking 54 and at least one secondary marking 56A, 56B, 56C, the identifier 53 of the mesh 50 depending on the position of each secondary marking 56A, 56B, 56C relatively to the main marking 54.

Each identification marking 52 is distinct from an alphanumerical coding, according to which each mesh 50 is distinguished from another mesh 50 by a different chain of alphanumerical character(s).

The identifier 53 for example includes at least one number X, Y, expressed in an arithmetic basis, in the described example, the identifier 53 includes two numbers, i.e. a first number X and a second number Y. The first number X and the second number Y respectively corresponding to the abscissa and to the ordinate of the mesh 50.

In the described example, the arithmetic basis is the decimal basis, and the figure(s) of the numbers X, Y are numerical values comprised between 0 and 9, as known per se. Alternatively, the arithmetic basis a basis N, N being an integer with a value greater than or equal to 2, wherein the figure(s) of the numbers X, Y are values comprised between 0 and N−1, as known per se.

In the example of FIG. 2, the identifier 53 includes two numbers X, Y, each secondary marking 56A, 56B, 56C corresponding to a respective figure of said number. Let us specify that in FIG. 2, the identifier 53 is given as an indication; of course it is not plotted on the marking device 28. Both numbers X, Y for example are with a value comprised between 0 and 999, and the identification marking then includes three secondary markings 56A, 56B, 56C, i.e. a first secondary marking 56A corresponding to the units of said number, a second secondary marking 56B corresponding to the tens of said number and a third secondary marking 56C corresponding to the hundreds of said number. In the example of FIG. 2, the secondary markings 56A, 56B, 56C are illustrated by lower case letters u, d, c, in order to facilitate the understanding of the coding used and to indicate which markings respectively correspond to the units, the tens and to the hundreds. One skilled in the art will understand that in practice the secondary markings 56A, 56B, 56C are for example geometrical shapes, including alphanumerical characters, in the form of discs, rings, triangles, rectangles, or further squares, as this will be described in more detail subsequently. On the other hand, according to this embodiment, for each mesh 50, each geometrical shape corresponds to a same secondary marking 56A, 56B, 56C. In other words, to each geometrical shape corresponds a same secondary marking 56A, 56B, 56C, said secondary marking 56A, 56B, 56C representing either the units, the tens or the hundreds.

When the identifier 53 includes two distinct numbers, each with a value comprised between 0 and 999, the marking device 28 according to the invention then allows the identification in a unique way of 1,000×1,000 different meshes 50, i.e. a million distinct meshes 50. When the value of the side A of each mesh 50 is equal to 100 μm, the sample support 24 then has dimensions ranging up to 10 cm×10 cm, i.e. dimensions greater than the typical dimensions of microscope slides, said slides generally being with a shape of a rectangle of 7.5 cm×2.5 cm.

The main marking 54 allows delimitation of the mesh 50, while each secondary marking 56A, 56B, 56C participates in the identification of the mesh 50, and therefore the localization of the position of this mesh 50. In other words, each secondary marking 56A, 56B, 56C allows determination of the identifier 53.

The main marking 54 preferably has an asymmetrical shape, in order to indicate the orientation of the mesh 50. The main marking 54, for example includes a first branch 58A and a second branch 58B, both branches 58A, 58B being connected in a common point 60, and the second branch 58B being with a length greater than that of the first branch 58A.

In the example of FIG. 2, the main marking 54 has the shape of an L. The first branch 58A for example indicates the direction of a first axis x-x′ of the meshing, and the second branch 58B indicates the direction of a second axis y-y′ of the meshing. The identifier 53 of a mesh 50 is then obtained by determining the respective coordinates of each secondary marking 56A, 56B, 56C according to the first axis x-x′ and the second axis y-y′. The orientation directed from the common point 60 to the free end of each branch 58A, 58B for example corresponds for each direction to the direction of increase of said coordinates.

In other words, according to this example, the meshing of the marking device 28 is produced along the first axis x-x′ and the second axis y-y′, the direction of the first axis x-x′, that of the second axis y-y′, respectively, being indicated by the direction of the first branch 58A, of that of the second branch 58B, respectively. In addition to the orientation of each axis x-x′, y-y′ of the meshing, the L shape of the main marking 54 gives the possibility of distinguishing the longest axis from the shortest axis. Thus, the main marking 54 with the shape of an L allows identification of each axis x-x′, y-y′ without any ambiguity. A possible confusion introduced by the turning over or the rotation of the marking device 28 or of the image resulting from the observation is then avoided. In the case when the main marking 54 with an L shape includes two branches 58A, 58B of identical length, each axis x-x′, y-y′ of the meshing will be identifiable for example by varying the width of each branch 58A, 58B, such as a thicker branch for the vertical axis y-y′.

Thus, generally, when the meshing includes two axis x-x′, y-y′, the main marking 54 includes two different shapes, aligned along the first axis x-x′ and the second axis y-y′ respectively of the meshing.

The main marking 54 has reduced dimensions as compared with those of the mesh 50. The main marking 54 has a size of dimensions of less than or equal to 50 μm×50 μm, preferably of dimensions less than or equal to 10 μm×20 μm. The length of the first branch 58A is for example equal to one tenth of the value of the side A, and the length of the second branch 58B is for example equal to one fifth of the value of the side A. The length of the first branch 58A is then preferably equal to 10 μm and that of the second branch 58B preferably equal to 20 μm. The thickness of the branches 58A, 58B for example is equal to 2 μm.

The main marking 54 for example has a same shape for the whole of the identification markings 52 present on the sample support 24. This unique shape of the main marking 54 for the whole of the identification markings 52 then gives the possibility of easily localizing each mesh 50.

Each secondary marking 56A, 56B, 56C is associated with a respective figure of the number(s) X, Y of the identifier 53. For example, the coordinates of each secondary marking 56A, 56B, 56C along the first axis x-x′ respectively represent the figure of the units, of the tens and of the hundreds of the coordinate of the mesh 50 along the first axis x-x′, these coordinates being determined by assuming as an origin a remarkable point of the main marking 54, notably the angle formed by the L, i.e. the common point 60. Also, the coordinates of each secondary marking 56A, 56B, 56C along the second axis y-y′ respectively represents the figure of the units, of the tens and of the hundreds of the coordinate of the mesh 50 along the second axis y-y′. The coordinates of the mesh 50 along the first and second axis x-x′, y-y′ of the meshing form the identifier 53 of the identification marking 52.

It is then understood that with each mesh 50 is assigned a reference system, the identifier 53 being determined from the coordinates of each secondary marking 56A, 56B, 56C in this reference system. Advantageously, the origin of the reference system of each mesh is placed at the main marking 54, the origin of the reference system for example being the common point 60.

Advantageously, the main marking 54 is configured for determining the distance between successive coordinates along each axis x-x′, y-y′. Thus, in the example of FIG. 2, the first branch 58A oriented along the first axis x-x′ indicates the distance between two successive abscisses x, x+1, i.e. two abscisses distant by one unit. The second branch 58B oriented along the second axis y-y′ indicates the distance between two ordinates y, y+2 distant by two units. The second branch 58B then also forms a scale for the second axis y-y′, while being of a length double that of the first branch 58A in order to define an orientation of the mesh 50 as indicated earlier. In other words, the main marking 54 forms a scale for determining the coordinates of each secondary marking 56A, 56B, 56C along each axis x-x′, y-y′ of the meshing.

Thus, the identifier 53 of the mesh 50 depends on the position, and notably on the distance, of the corresponding secondary marking 56A, 56B, 56C with respect to the main marking 54, and more specifically on the coordinates of each secondary marking 56A, 56B, 56C in a reference system associated with each mesh 50, said reference system being oriented along the axis x-x′, y-y′ of the meshing, the origin of the reference system preferably being associated with the main marking 54.

In the example of FIG. 2, the first secondary marking 56A is of an abscissa equal to 3, the second secondary marking 56A is of an abscissa equal to 2, and the third secondary marking 56C is of an abscissa equal to 1, so that the first number X of the identifier 53 is equal to 123. Similarly, the first secondary marking 56A is of an ordinate equal to 6, the second secondary marking 56A is of an ordinate equal to 5, and the third secondary marking 56C is of an ordinate equal to 4, so that the second number Y of the identifier 53 is equal to 456.

In the example of FIGS. 2 and 3, each secondary marking 56A, 56B, 56C is of a distinct size from one secondary marking to the other. The first secondary marking 56A corresponding to the units of the numbers X, Y is for example the secondary marking of the smallest size, the second secondary marking 56B corresponding to the tens of the numbers X, Y is the secondary marking of an intermediate size, and finally the third secondary marking 56C corresponding to the hundreds of the numbers X, Y is the secondary marking of the largest size. The three secondary markings 56A, 56B, 56C are all of a circular shape, for example with the shape of rings of different radii, in the example of FIGS. 2 and 3. This allows coding of an identifier 53 wherein the three figures of the number X, Y have the same value, the three secondary markings 56A, 56B, 56C then being concentric.

The first secondary marking 56A is for example of the shape of a disc with a diameter equal to 2 μm, and the second secondary marking 56B is of the shape of a ring with an internal diameter equal to 2 μm and an external diameter equal to 4 μm, as illustrated in FIG. 3 wherein the image was acquired with an objective 38 of magnification ×40. In the example of FIG. 3, the numbers X, Y of the identifier 53 are comprised between 0 and 99, so that the identification marking 52 does not include any third secondary marking. One skilled in the art will understand that in the case when one of the numbers X, Y is greater than or equal to 100 and when a third secondary marking 56C is then required, the third secondary marking 56C is for example of the shape of a ring with an internal diameter equal to 4 μm and an external diameter equal to 6 μm.

Alternatively, each secondary marking 56A, 56B, 56C is substantially of the same size, but with a distinct shape from one secondary marking to the other. As an example, the first secondary marking 56A is of the shape of a disc, the second secondary marking 56B is of the shape of a triangle and the third secondary marking 56C is of the shape of a square.

Still alternatively, each secondary marking 56A, 56B, 56C has a size and shape distinct from one secondary marking to the other.

Each secondary marking 56A, 56B, 56C has a size of dimensions of less than or equal to 10 μm×10 μm.

Thus, the identification marking 52 associated with the mesh 50 gives the possibility of marking the mesh 50 with the identifier 53 corresponding to the identification marking. This marking is unique when the identifier 53 is unique for each mesh 50.

Further, the marking device 28 equipped with identification markings 52 according to the invention considerably facilitates observation of the different elements of the sample 26, when the main marking 54 and the secondary marking(s) 56A, 56B, 56C are of reduced dimensions as compared with those of the mesh 50.

Regardless of the embodiment, the identification markings 52 of the marking device 28 according to the invention allow unique identification of the different observation areas of a sample support 24 having dimensions ranging up to 10 cm×10 cm, i.e. dimensions greater than the typical dimensions of microscope slides.

Further, the identification marking(s) 52 according to the invention give the possibility of determining at which scale the image of the sample 26 is acquired, the dimensions of the main marking 54 being predetermined and known.

It is thus conceivable that the marking device 28 according to the invention gives the possibility of easily localizing a mesh 50 from among the whole of the meshes 50 of the device, while facilitating observation of the different elements of the sample 26 inside the mesh 50.

Regardless of the embodiment, the main marking 54 and each secondary marking 56A, 56B, 56C are adapted in order to appear in a contrasted way in the image acquired by the image acquisition device 29. The main marking 54 and each secondary marking 56A, 56B, 56C are for example in an opaque and reflecting material when the sample support 24 is transparent. In this case, they appear dark on a bright background, when they are observed in transmission, or bright on a dark background when they are observed in reflection. Alternatively, the main marking 54 and each secondary marking 56A, 56B, 56C are for example absorbing, respectively reflecting, when the sample support 24 is respectively reflecting, respectively absorbing.

Generally, each marking 54, 56A, 56B, 56C is configured so as to appear in a contrasted way relatively to the sample support 24, for a given observational method.

The main marking 54 and each secondary marking 56A, 56B, 56C are for example made in the following way. The marking device 28 is covered with a thin layer of platinum oxide by physical vapour deposition, also called PVD. This layer of platinum oxide is then removed by laser photolithography over the whole surface except in the locations of the markings 54, 56A, 56B, 56C.

Alternatively, the main marking 54 and each secondary marking 56A, 56B, 56C are produced by screen printing or microetching.

Each marking 54, 56A, 56B, 56C is for example made in a material which may be used as a reference for a spectroscopic measurement, this material having a predetermined optical property. By optical property is meant a fluorescence or Raman scattering property.

Regardless of the embodiment, the identification marking 52 is for example positioned on the face bearing the sample 26 or on the face opposite to the face bearing the sample 26. The first alternative is preferred for reasons of field depth.

Generally, the main marking 54 and each secondary marking 56A, 56B, 56C are for example positioned on the face in contact with the sample or on the face opposite to the face bearing the sample. The first alternative is preferred for reasons of field depth, and this regardless of the embodiment.

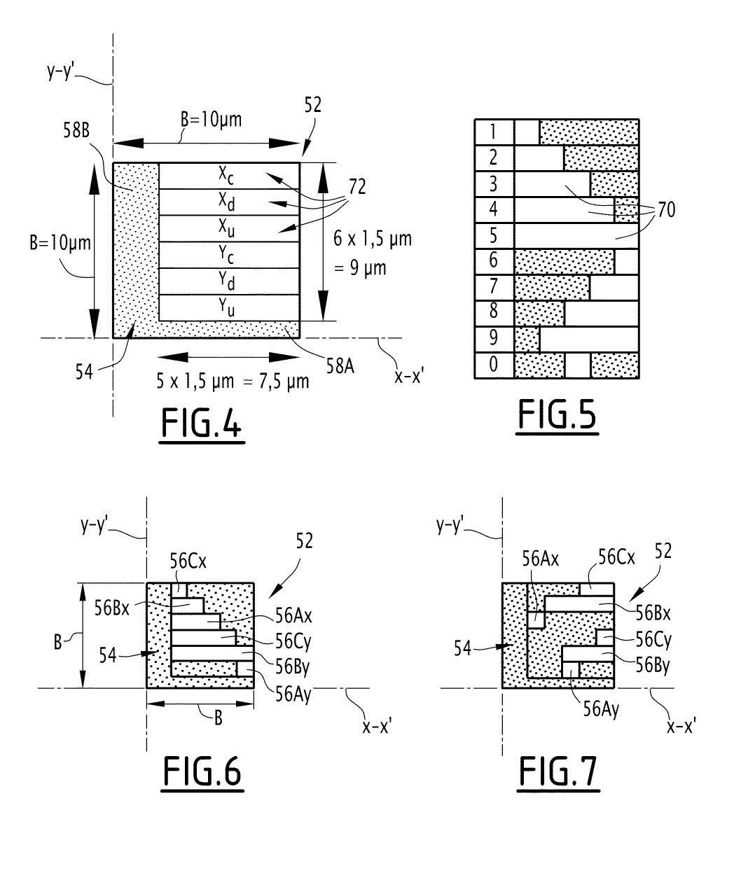

FIGS. 4 to 8 illustrate an additional aspect for which the elements similar to the embodiment described earlier are marked with identical references, and are not described again.

According to this additional aspect, each identification marking 52 is of the shape of a terminal for which the size is included in a square of side B, as illustrated in FIGS. 4 and 6 to 8. The value of the side B is for example equal to 10 μm.

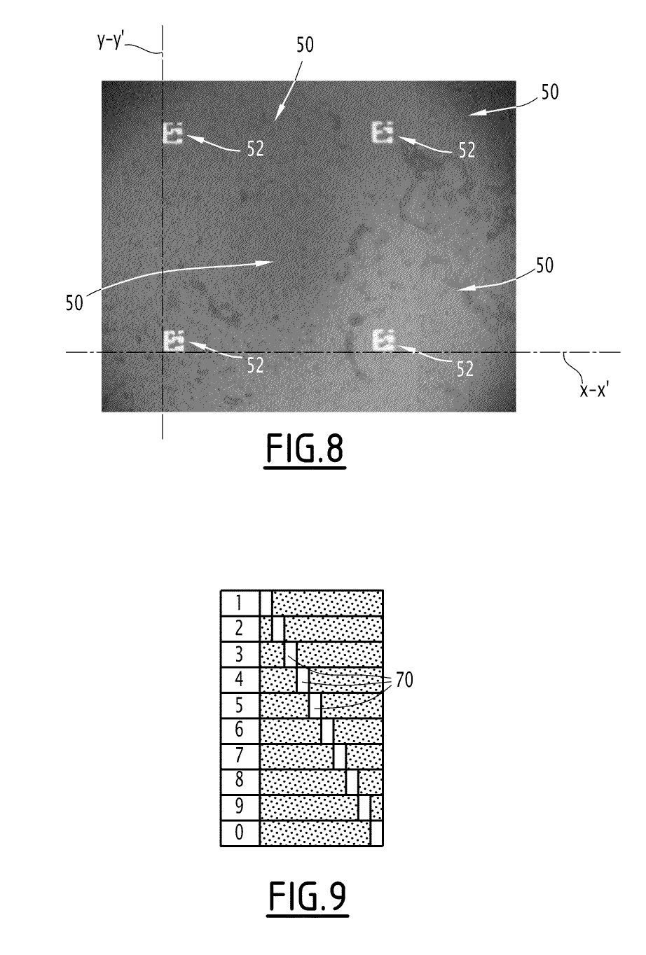

As this may be seen in FIG. 8, each terminal allows delimitation and identification of each mesh 50 of the marking device 28.

The main marking 54 preferably has an asymmetrical shape, in order to indicate an orientation of said marking. Such a marking 54, for example with the shape of an L, includes the same advantages as those shown in the description of the embodiment described earlier. The first branch 58A and the second branch 58B are of substantially identical lengths and have different thicknesses. The first branch 58A is for example less thick than the second branch 58B.

In the example of FIG. 4, the thickness of the first branch 58A is equal to 1 μm, and that of the second branch 58B is equal to 2.5 μm.

Each secondary marking 56A, 56B, 56C is of the shape of a rectangular area 70 of a variable length depending on the value of the figure to which each secondary marking 56A, 56B, 56C corresponds, as illustrated in FIG. 5 where the secondary markings 56A, 56B, 56C correspond to blank areas, i.e. transparent areas of the identification marking 52. In the example of FIG. 5, the arithmetic base is the decimal base, and FIG. 5 illustrates the different rectangular areas 70 each corresponding to different values of the figures comprised between 0 and 9 in the decimal base. In other words, the pattern of each secondary marking 56A, 56B, 56C corresponds to an alphanumerical character, in the case a figure, the correspondence between said pattern and said character forming a code as the one illustrated in FIG. 5 or as the one illustrated in FIG. 9.

Thus, generally, according to this additional aspect, each mesh 50 is associated with a respective identification marking 52 with a shape of a terminal, each identification marking 52 including a secondary marking 56A, 56B, 56C, of a predetermined geometrical shape, for example in the shape of a rectangular strip 70, the position of which with respect to the main marking 54, and optionally the pattern, give information as to the identifier 53 associated with the identification marking 52, said pattern being determined according to a code. The rectangular areas 70 are preferably parallel with each other in the case of a plurality of secondary markings 56A, 56B, 56C. The rectangular areas 70 are for example positioned in strips 72 parallel with each other, preferably parallel with one of the branches 58A, 58B, each strip 72 being associated with a respective secondary marking 56A, 56B, 56C for a respective number X, Y as illustrated in FIG. 4. In other words, one has a first set of secondary markings 56Ax, 56Bx, 56Cx allowing identification of the terminal along the first axis x-x′ of the meshing, and of a second set of secondary markings 56Ay, 56By, 56Cy according to the second axis y-y′ of the meshing.

In the example of FIG. 4, the identification marking 52 includes six strips 72, parallel to the first branch 58A, noted Xc, Xd, Xu, Yc, Yd, Yu respectively from the far most strip 72 of the first branch 58A and moving up to the strip 72 in contact with the first branch 58A. The first secondary marking 56Ax corresponding to the units of the first number X, the second secondary marking 56Bx corresponding to the tens of the first number X and the third secondary marking 56Cx corresponding to the hundreds of the first number X are then positioned in the strips noted as Xu, Xd and Xc, respectively. In a similar way, the first secondary marking 56Ay corresponds to the units of the second number Y, the second secondary marking 56By corresponds to the tens of the second number Y and the third secondary marking 56Cy corresponds to the hundreds of the second number Y and are positioned in the strips noted as Yu, Yd and Yc respectively.

The identification marking 52 includes a predetermined number of strips 72, the value of said predetermined number being selected according to the amount of numbers X, Y which the identifier 53 includes, as well as to the values assumed by these numbers X, Y. As an example, one skilled in the art will understand, that in the case when the identifier 53 includes two numbers X, Y, each with a value comprised between 0 and 9,999, then the number of strips 72 is equal to 8. Alternatively, if the identifier 53 includes three numbers X, Y, W each with a value comprised between 0 and 999, then the number of strips 72 is equal to 9.

According to this convention, the identification marking 52 illustrated in FIG. 6 corresponds to the identifier for which the first number X is equal to 123 and for which the second number Y is equal to 456. As an additional example, the identification marking 52 illustrated in FIG. 7 corresponds to the identifier for which the first number X is equal to 791 and for which the second Y is equal to 680.

In the example of FIGS. 4 to 8, each strip 72 has a length of about 7.5 μm and a thickness of about 1.5 μm.

The strips 72 are preferably placed side by side. The whole of the six strips 72 in the example of FIGS. 4 and 6 to 8 then has a thickness of about 9 μm for a length of about 7.5 μm.

One skilled in the art will also understand that the length of the branch from among the first branch 58A and the second branch 58B which is not parallel to the strips 72 is adapted to the numbers of strips 72 which the identification marking 52 includes. In the example of FIG. 4, the length of the second branch 58B is thus adapted to the numbers of strips 72 which the identification marking 52 includes. As an example, when each strip 72 has a thickness of about 1.5 μm, if the number of strips 72 is equal to 6 then the length of the second branch 58B is equal to 10 μm, and if the number of strips 72 is equal to 8 then the length of the second branch 58B is equal to 13 μm.

One skilled in the art will also understand that codings other than the ones illustrated in FIG. 5 are possible. Alternatively, each secondary marking 56A, 56B, 56C is of the shape of a rectangular area 70 with a set length, as illustrated in FIG. 9 wherein the secondary markings 56A, 56B, 56C correspond to the blank areas, i.e. the transparent areas of the identification marking 52. In the example of FIG. 9, the arithmetic base is the decimal base, and FIG. 9 illustrates the different rectangular areas 70 corresponding to the different values of the figures comprised between 0 and 9 in the decimal base. According to this alternative, the value of the number depends on the position of the rectangular area 70 inside the strip 72.

In the example of FIG. 9, representing a code distinct from the one of FIG. 5, each strip 72 has a length of about 7.5 μm and a thickness of about 1.5 μm. Each rectangular area 70 then has the length of about 0.75 μm.

According to an alternative of this additional aspect, the size of certain identification markings 52 is different from that of the other identification markings 52. Certain identification markings 52 have a larger size than the others, this in order to adapt to optics of different magnifications.

The advantages of this additional aspect are similar to those of the embodiment described earlier, and are not again described.

It is thus conceivable that the marking device 28 according to the invention gives the possibility of easily localizing a mesh 50 from among the whole of the meshes 50 of the marking device 28, while facilitating the observation of different elements of the sample 26 inside the mesh 50.

In the embodiment discussed earlier, sample supports 24 were described, on which the sample 26 is intended to be deposited, these sample supports 24 integrating the marking device 28 according to the invention.

The invention also applies to marking devices 28 intended to be placed facing the sample support 24. Such marking devices 28 include a meshed support, on which are made the identification marking(s) 52 as defined earlier. This meshed support is then placed between the light source 22 and the sample support 24, in which case the meshed support is transparent.

The sample support 24 is alternatively positioned between the meshed support and the light source 22, in which case the sample support 24 has to be transparent.

Such a meshed support for example appears as a small strip intended to be applied against the sample support 24, while being maintained secured to the latter. For example this is a transparent small strip intended to cover the sample 26, the latter then being located between the sample support 24 and said small strip. Alternatively this is a small strip intended to be applied under the transparent sample support 24, the sample 26 then being positioned on the sample support 24, the latter being applied against the small strip.

Thus, generally, the marking device 28 according to the invention is intended to be positioned facing the sample 26 placed on the sample support 24, the marking device 28 allowing spatial marking of the sample 26 on said sample support 24. The marking device 28 is integrated to the sample support 24 itself, or else the marking device 28 is alternatively distinct from the sample support 24, for example by being applied against the support 24 bearing the sample 26.

1. A marking device for marking a sample, the marking device being intended to be placed facing the sample for observing the sample by means of an observation system, the marking device comprising a plurality of meshes forming a meshing, the marking device comprising at least one identification marking for each mesh,
each identification marking corresponding to an identifier of the mesh and including a main marking and at least one secondary marking, the identifier of said mesh depending on the position of each secondary marking with respect to the main marking,
wherein each identification marking includes a plurality of secondary markings, and
in that the identifier includes a first number and a second number, both numbers being expressed in a respective arithmetic base, and each secondary marking both corresponds to a respective figure of the first number and to a respective figure of the second number.

2. The marking device according to claim 1, wherein the identification marking, including the main marking and each secondary marking, is distinct from alphanumerical coding.

3. The marking device according to claim 1, wherein the main marking has an asymmetrical shape able to indicate an orientation of said meshing.

4. The marking device according to claim 1, wherein the arithmetic base is the decimal base.

5. The marking device according to claim 1, wherein the value of the figure depends on the distance between the corresponding secondary marking and the main marking.

6. The marking device according to claim 1, wherein each mesh includes a reference system, the identifier being determined from the coordinates of each secondary marking in this reference system.

7. The marking device according to claim 1, wherein each mesh includes a reference system, and the main marking forms a scale for determining at least one coordinate of each secondary marking along at least one axis of this reference system.

8. The marking device according to claim 7, wherein the main marking forms a scale for determining the coordinates of each secondary marking along each axis of the reference system.

9. The marking device according to claim 1, wherein each secondary marking has a size of dimensions of less than or equal to 10 μm×10 μm.

10. The marking device according to claim 1, wherein the secondary markings are of a distinct size and/or shape from one secondary marking to the other.

11. The marking device according to claim 1, wherein the main marking has a size of dimensions of less than or equal to 20 μm×40 μm.

12. An observation system comprising a sample support, a light source able to illuminate the sample support, and a marking device for marking a sample, the sample being intended to be positioned on the sample support, characterized in that the marking device is according to claim 1.

13. The observation system according to claim 12, wherein the marking device is positioned facing the sample support.

14. The observation system according to claim 12, wherein the sample support includes a plate for receiving the sample, and the marking device is made on said plate.

15. The marking device according to claim 1, wherein the secondary markings are of a distinct shaped from one secondary marking to the other.
